(19) United States
(12) Patent Application Publication
(10) Pub. No.: US 2025/0205916 A1
(43) Pub. Date: Jun. 26, 2025

(54) FOOD PRODUCT SLICER AND SLICER SYSTEM

(71) Applicant: ILLINOIS TOOL WORKS INC., Glenview, IL (US)

(72) Inventors: Matthew W. BIRD, Xenia, OH (US); Thomas P. JONES, Wilmington, OH (US)

(21) Appl. No.: 18/927,393

(22) Filed: Oct. 25, 2024

Related U.S. Application Data
(60) Provisional application No. 63/612,820, filed on Dec. 20, 2023.

(51) Int. Cl. B26D 7/06; B26D 1/153; B26D 7/00; B26D 7/01; B26D 7/30

(52) U.S. Cl. CPC B26D 7/0616; B26D 7/01; B26D 7/30; B26D 1/153; B26D 2007/0018; B26D 2210/02

(57) ABSTRACT

A food product slicer system includes a food product slicer that includes a base, a knife mounted for rotation relative to the base, a carriage assembly mounted to the base for reciprocal movement back and forth past a cutting edge of the knife, and a gauge plate mounted for movement between a closed position that prevents slicing and multiple open positions that permit slicing at respective thicknesses. The base includes an external housing and also includes a inset region at a sliced food product drop side of the knife. A tray is removably positionable in the inset region and has a bin portion for catching food product slices and an upper mating portion extending outward from the bin and that overlaps with upper surface regions of the housing. In implementations, the system includes a weighing scale that can be interchanged with the tray.

### TECHNICAL FIELD

This application relates generally to food product slicers of the type commonly used to slice bulk food products and, more specifically, to a modular food product slicer adapted for use with different accompanying components.

### BACKGROUND

Typical reciprocating food slicers have a rotatable, circular or disc-like slicing blade, an adjustable gauge plate for determining the thickness of the slice and a carriage for supporting the food as it is moved back and forth past the cutting edge of the knife during slicing. A drive motor may be linked to drive the carriage back and forth during an automatic slicing operation carried out by a controller of the slicer and/or manual carriage operation is possible. The gauge plate is situated along the edge of the knife toward the front of a slicing stroke and is laterally movable with respect to the knife for determining the thickness of the slices to be cut. A rotatable adjustment or indexing knob is provided for manually setting a spacing between the plane of the gauge plate surface and the plane of the knife edge for the purpose of slicing so that operators can select a thickness of slices to be produced. Such slicers commonly have a base with a surface area on the back side of the knife, onto which the sliced food product falls, or onto which a food catchment paper is placed to catch the food product.

One prior slicer included a base configured with a corner section cutout in the area where the sliced food product falls. This enabled a food catchment tray to be placed in the cutout region to catch the food product. The food catchment tray was formed by a perimeter rim forming a modest rim recess, and a tray base extending upwardly from the recess by about 1 inch. The catchment tray rested on the surface supporting the slicer, and did not engage the slicer for position retention.

It would be desirable to provide a slicer with a modularity feature that is more useful in the slicer operating environment.

### SUMMARY

In one aspect, a food product slicer system comprises a food product slicer that includes a base, a knife mounted for rotation relative to the base, a carriage assembly mounted to the base for reciprocal movement back and forth past a cutting edge of the knife, and a gauge plate mounted for movement between a closed position that prevents slicing and multiple open positions that permit slicing at respective thicknesses, wherein the base includes an external housing and also includes a inset region at a sliced food product drop side of the knife. The system further includes a tray removably positioned in the inset region and having a bin portion for catching food product slices and an upper mating portion extending outward from the bin and that overlaps with upper surface regions of the housing.

In another aspect, a food product slicer system comprises a food product slicer that includes a base, a knife mounted for rotation relative to the base, a carriage assembly mounted to the base for reciprocal movement back and forth past a cutting edge of the knife, and a gauge plate mounted for movement between a closed position that prevents slicing and multiple open positions that permit slicing at respective thicknesses, wherein the base includes an external housing and also includes a inset region at a sliced food product drop side of the knife. The system further includes a weighing scale removably positioned within the inset region for catching and weighing food product slices, wherein the weighing scaled includes a control that is connected to a control of the food product slicer via a communications link.

In a further aspect, a food product slicer system comprises a food product slicer that includes a base, a knife mounted for rotation relative to the base, a carriage assembly mounted to the base for reciprocal movement back and forth past a cutting edge of the knife, and a gauge plate mounted for movement between a closed position that prevents slicing and multiple open positions that permit slicing at respective thicknesses, wherein the base includes an external housing and also includes a inset region at a sliced food product drop side of the knife. The system further includes a food catch tray and a weighing scale. The food catch tray is removably positionable in the inset region to establish a first slicer system configuration, and the weighing scale is removably positionable in the inset region to establish a second slicer system configuration.

### BRIEF DESCRIPTION OF DRAWINGS

FIGS. 1 and 2 show perspective views of a food product slicer;

FIGS. 3-4 show views of a food product slicer system including the food product slicer and a tray;

FIGS. 5-6 show views of the tray in isolation;

FIGS. 7A-7B and 8-9 show partial views of the system of FIGS. 3-4;

FIG. 10 shows a food product slicer system including the food product slicer and a weighing scale; and

FIG. 11 shows a food product slicer system including the food product slicer and a deep bin.

### DETAILED DESCRIPTION

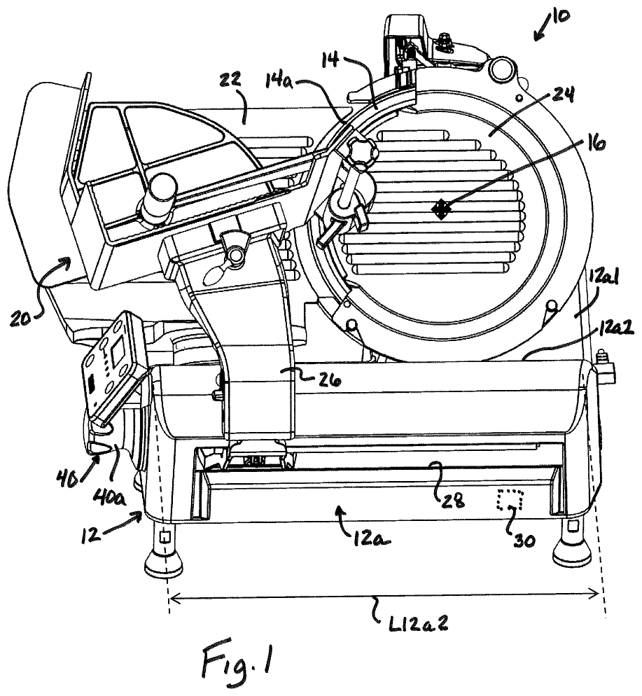

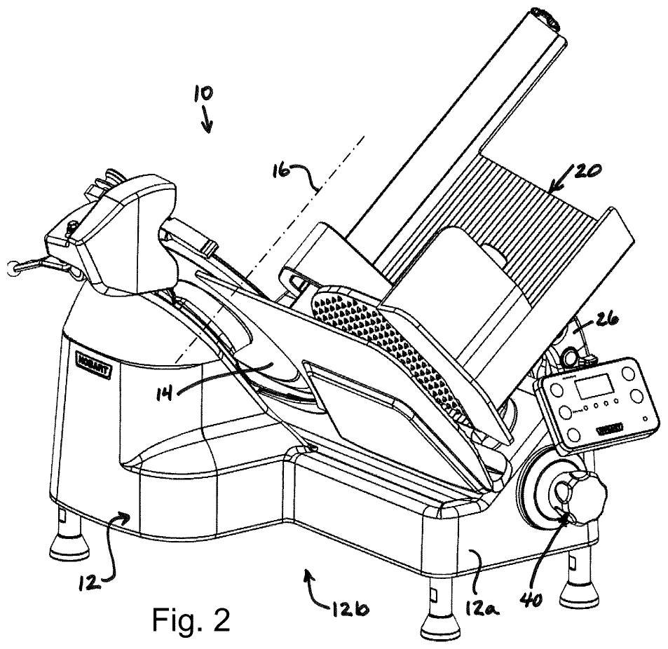

Referring to FIGS. 1-2, a food product slicer 10 includes a base 12 and a circular, motor-driven slicing knife 14 that is mounted to the base for rotation about an axis 16. The left side of FIG. 1, where the controls are located and an operator is located during slicing, is generally referred to as the front side of the slicer (which is where an operator stands for slicing), and the right side of FIG. 1 is generally referred to as the rear side of the slicer. A food product can be supported on a manually operable (or motor driven) food carriage 20 which moves the food product to be sliced past the cutting edge 14a of the rotating slicing knife 14. The food carriage 20 reciprocates from left to right relative to FIG. 1, along a linear path so that the lower end of the bulk food product slides along the surface of a gauge plate 22, is cut by the knife 14 and then slides along a knife cover plate 24. Food carriage 20 includes a tray mounted on a tray arm 26 that orients the food carriage tray at the appropriate angle (typically perpendicular) to the knife cutting-edge plane. The food carriage arm reciprocates in a slot 28 at a lower portion of an external, upper housing 12a of the base 12. The carriage 20 can be moved manually (e.g., by a handle) and/or the carriage 20 may also be automatically driven (e.g., as by an internal motor 30 that drives a belt that is linked internally to the arm). A gauge plate system includes a rotatable knob 40 (connected to an opening in the base 12) that includes a grip part 40a and an internal cam part that is linked to the gauge plate 22 such that rotation of the knob 40 effects movement the gauge plate, relative to a plane of the knife edge 14a, to adjust slice thickness. Generally, the gauge plate 22 moves along an axis that runs parallel to the axis 16, such that the food product contact surface of the gauge plate 22 remains substantially parallel to the plane of the knife edge 14a.

The base 12 is shaped to define an inset corner region 12b at a sliced food product drop side of the knife 14, which region 12b is bounded on two sides by external surface portions of the housing 12a. This inset corner region 12a is a region where the base 12 is not present, and enables the food product slicer 10 to be used in a modular manner, creating various food product slicer system configurations. Variations are possible, such as an inset region that is U-shaped and bounded on three sides by external surface portions of the housing.

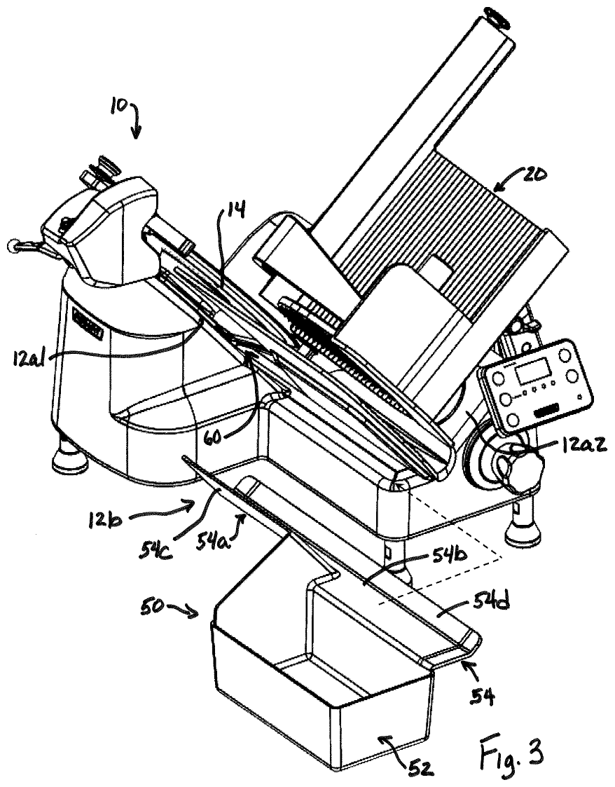

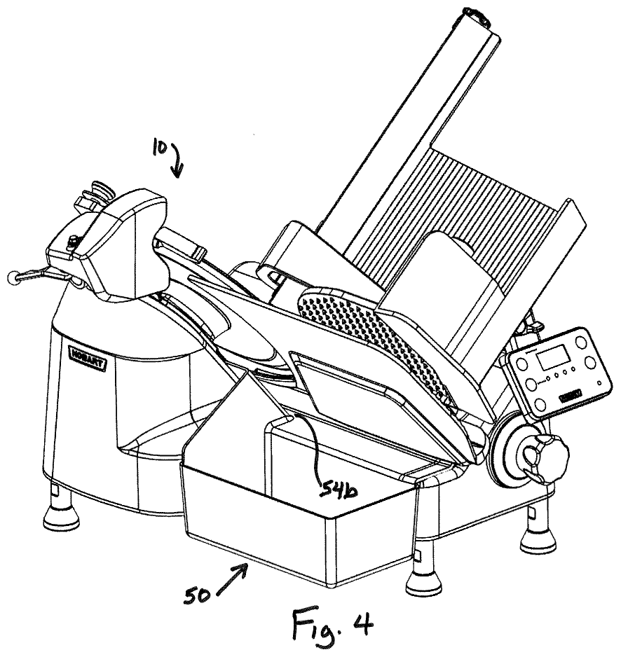

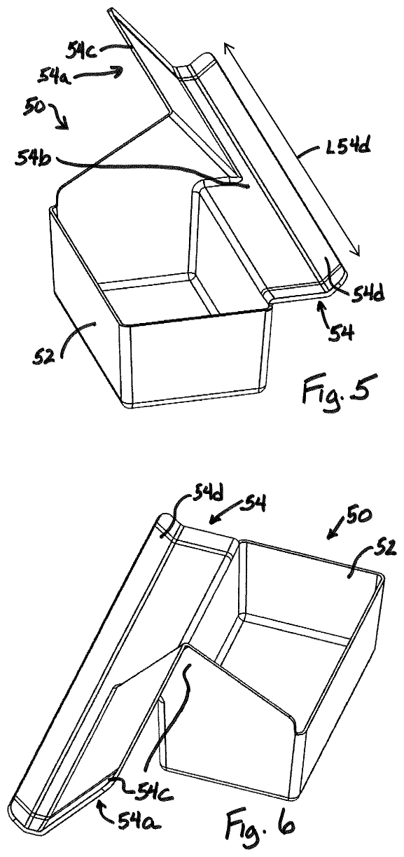

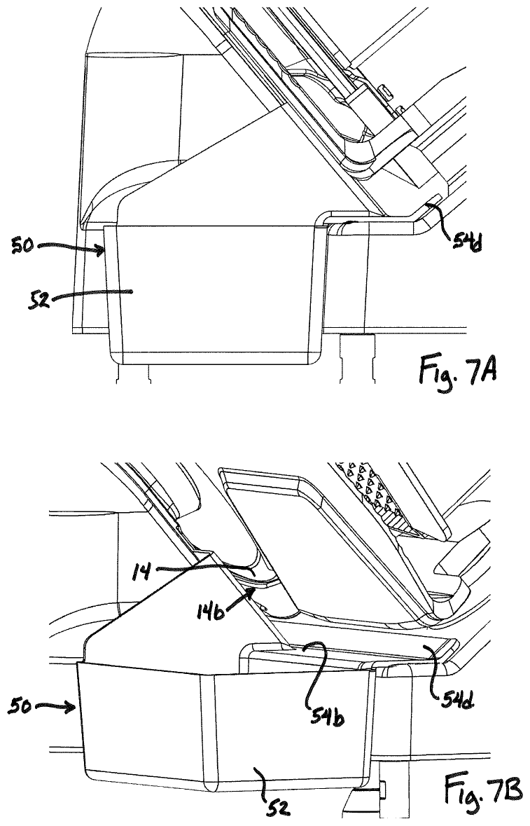

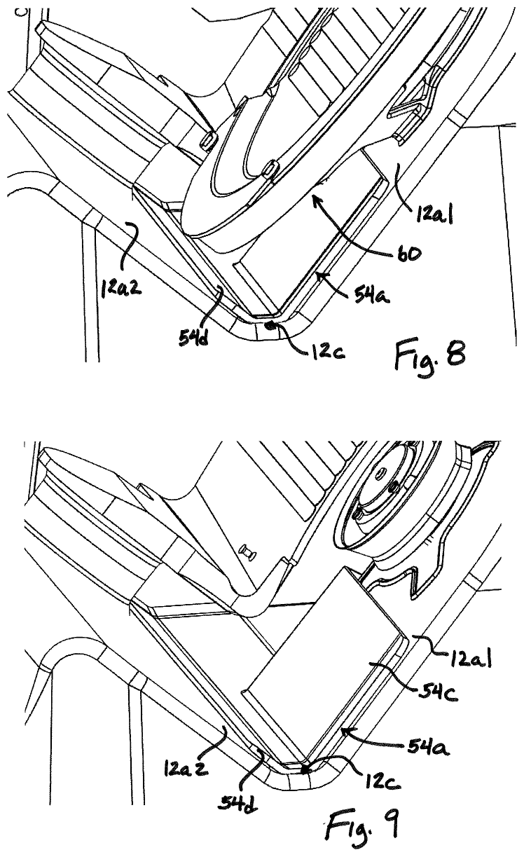

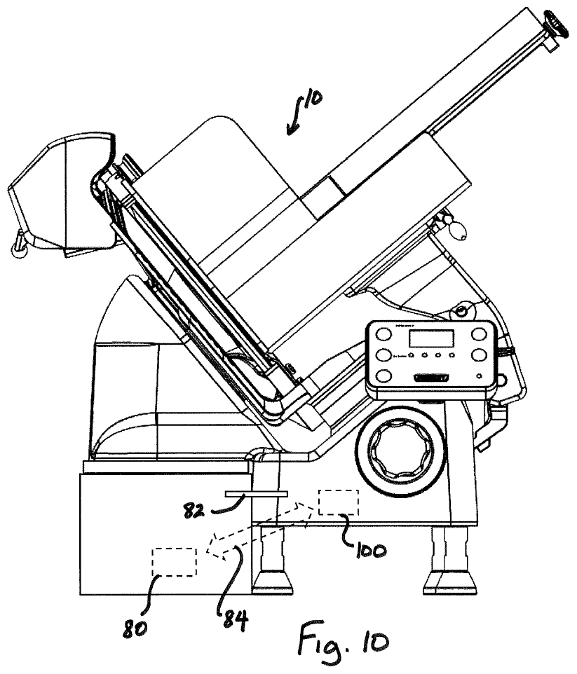

Referring to FIGS. 3-9, in one implementation, a food product slicer system includes the food product slicer 10 in combination with a removable tray 50. The tray can be removably positioned in the inset corner region 12b and has a bin portion 52 for catching food product slices and an upper mating portion 54 extending outward from the bin 52 and that overlaps with upper surface regions of the housing 12a. Here, the housing 12a includes an upwardly extending knife mount portion 12a1, and the upper mating portion 54 of the tray 50 includes a retaining segment 54a that extends into a gap 60 between the knife mount portion 12a1 of the housing and the knife 14, and the retaining segment 54a has a shape that conforms, at least in part, to a shape of the upwardly extending knife mount portion 12a1 of the housing 12a. The housing 12a also includes an upwardly extending carriage support portion 12a2. At least part of the carriage support portion 12a2 (e.g., a portion near the rear side of the food product slicer) is opposed to at least part of the knife mount portion 12a1 to define a trough-shaped region 12c of the housing, and the retaining segment 54a is shaped to conform to the trough-shaped region 12c. Here, the trough-shaped region and the retaining segment 54a are generally V-shaped, but variations are possible. The mating configuration of the retaining segment 54a to the housing 12 provides a nested arrangement of the upper mating portion 54 with the shape of the upper side of the slicer housing and aides in proper positioning and retention of the tray in the desired position during food product slicing operations.

Moreover, the upper mating portion 54 of the tray includes a food debris catch segment 54b that is trough-shaped and spaced from the bin 52 and that is positioned below a region 14b of the knife 14 from which food debris falls during slicing operations. Here, the trough-shaped configuration enables the catch segment 54b to better capture and hold the food debris. Desirably, this provides a configuration in which the segment 54b catches small food debris and maintains the food debris separate from the food product slices that fall into the bin 52.

From the above, it is seen that the upper mating portion 54 of the tray 50 includes both a segment 54c that extends upward along and conforms to portions of the knife mount portion 12a1 of the housing and a segment 54d that extends upward along and conforms to portions of the carriage support portion 12a2. Here, the segment 54d, along with the flat portion between segment 54c and segment 54d, has a length L54d that extends along a majority (e.g., along at least 70%, or along at least 80% or along at least 90%) of a front to back length L12a2 of the carriage support portion or the base itself.

In certain implementations, the food product slicer 10 may be installed on a surface such that a depth of the bin 50 extends below a bottom plane 10a of the food product slicer (e.g., where the bottom plane is defined by support feet 11 on the slicer). FIG. 11 schematically shows one example of such an arrangement, in which the support feet 11 sit on raised support structures 13 atop a counter or other support surface 15, and the bin 50 also sits on the counter 15. The support structures 13 could also be formed as part of a cart structure on which the slice sits, and could be adjustable in height. In another embodiment, the counter or support surface 15 itself could be specifically formed with a lowered corner section that aligns with the inset corner of the food slicer, allowing a lower bin placement.

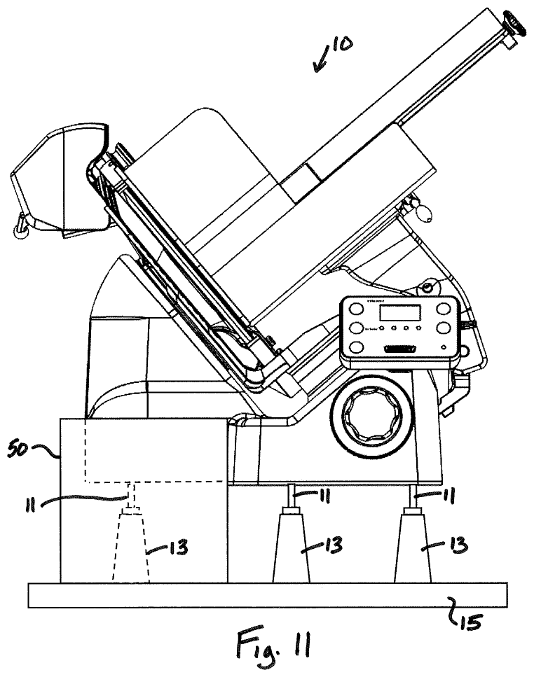

Referring now to FIG. 10, in another implementation, a food product slicer system includes the food product slicer 10 in combination with a weighing scale 70. The weighing scale 70 is removably positioned within the inset corner region such that a weigh platter 72 of the scale catches and weighs food product slices as they are cut. The weighing scale 70 includes a controller 80 that is connected to a controller 100 of the food product slicer 10 via a communications link. The communications link may be a hardwire link 82 from the weighing scale to the food product slicer or a wireless link 84 from the weighing scale to the food product slicer. As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group-including hardware or software that executes code), software, firmware and/or other components, or a combination of some or all of the above, that carries out the control functions of the machine or the control functions of any component thereof.

It is to be clearly understood that the above description is intended by way of illustration and example only and is not intended to be taken by way of limitation. Variations are possible.

1. A food product slicer system, comprising:
a food product slicer, including:
a base;
a knife mounted for rotation relative to the base;
a carriage assembly mounted to the base for reciprocal movement back and forth past a cutting edge of the knife;
a gauge plate mounted for movement between a closed position that prevents slicing and multiple open positions that permit slicing at respective thicknesses;
wherein the base includes an external housing and also includes an inset region at a sliced food product drop side of the knife;
a tray removably positioned in the inset region and having a bin portion for catching food product slices and an upper mating portion extending outward from the bin and that overlaps with upper surface regions of the housing.

2. The food product slicer of claim 1, wherein the inset region is configured as an inset corner region that is bounded, in top plan view, on only two sides by surface portions of the housing.

3. The food product slicer system of claim 1, wherein the housing includes an upwardly extending knife mount portion, wherein the upper mating portion of the tray includes a retaining segment that extends into a gap between the knife mount portion of the housing and the knife, wherein the retaining segment has a shape that conforms, at least in part, to a shape of the upwardly extending knife mount portion of the housing.

4. The food product slicer system of claim 3, wherein the housing includes an upwardly extending carriage support portion, wherein at least part of the carriage support portion is opposed to at least part of the knife mount portion to define a trough-shaped region of the housing, wherein the retaining segment is shaped to conform to the trough-shaped region.

5. The food product slicer system of claim 1, wherein the upper mating portion of the tray nests, at least in part, with an upper surface shape defined by upper surface regions of the housing.

6. The food product slicer of claim 5, wherein the upper mating portion of the tray is trough-shaped.

7. The food product slicer system of 1, wherein the upper mating portion of the tray includes a food debris catch segment that is spaced from the bin and that is positioned below a region of the knife from which food debris falls during slicing operations so as to catch the food debris and maintain the food debris separate from food product slices that fall into the bin.

8. The food product slicer system of claim 1, wherein the housing includes an upwardly extending knife mount portion and an upwardly extending carriage support portion, wherein the upper mating portion of the tray includes a first segment that extends upward along and conforms to portions of the knife mount portion of the housing and a second segment that extends upward along and conforms to portions of the carriage support portion.

9. The food product slicer system of claim 8, wherein the second segment has a length that extends along a majority of a front to back length of the carriage support portion.

10. The food product slicer system of claim 1, wherein the food product slicer is installed on a surface such that a depth of the bin extends below a bottom plane of the food product slicer.

11. The food product slicer system of claim 1, further comprising:
a weighing scale removably positionable within the inset region for catching and weighing food product slices when the tray is removed from the inset region.

12. The food product slicer of claim 11, wherein the weighing scale includes a controller that is connected to a controller of the food product slicer via a communications link, when the weighing scale is positioned in the inset region.

13. A food product slicer system, comprising:
a food product slicer including:
a base;
a knife mounted for rotation relative to the base;
a carriage assembly mounted to the base for reciprocal movement back and forth past a cutting edge of the knife;
a gauge plate mounted for movement between a closed position that prevents slicing and multiple open positions that permit slicing at respective thicknesses;
wherein the base includes an external housing and also includes a inset region at a sliced food product drop side of the knife;
a weighing scale removably positioned within the inset region for catching and weighing food product slices, wherein the weighing scaled includes a controller that is connected to a controller of the food product slicer via a communications link.

14. The food product slicer system of claim 13, wherein the communications link comprises one of a hardwire link from the weighing scale to the food product slicer or a wireless link from the weighing scale to the food product slicer.

15. A food product slicer system, comprising:
a food product slicer, including:
a base;
a knife mounted for rotation relative to the base;
a carriage assembly mounted to the base for reciprocal movement back and forth past a cutting edge of the knife;
a gauge plate mounted for movement between a closed position that prevents slicing and multiple open positions that permit slicing at respective thicknesses;
wherein the base includes an external housing and also includes a inset region at a sliced food product drop side of the knife;
a food catch tray;
a weighing scale;
wherein the food catch tray is removably positionable in the inset region to establish a first slicer system configuration;
wherein the weighing scale is removably positionable in the inset region to establish a second slicer system configuration.
